(19) United States
(12) Patent Application Publication
(10) Pub. No.: US 2023/0115508 A1
(43) Pub. Date: Apr. 13, 2023

(54) METHOD FOR DETECTING A DRONE WITH A USER EQUIPMENT LOCATED ON-BOARD, CORRESPONDING DEVICES AND COMPUTER PROGRAMS

(71) Applicant: Orange, Issy-les-moulineaux (FR)

(72) Inventors: Antoine Mouquet, Chatillon Cedex (FR); Dinh Thuy Phan Huy, Chatillon Cedex (FR)

(21) Appl. No.: 17/914,732

(22) PCT Filed: Mar. 22, 2021
(86) PCT No.: PCT/FR2021/050468

§ 371 Date: Sep. 26, 2022

(30) Foreign Application Priority Data
Mar. 27, 2020 (FR) 2003044

(51) Int. Cl. H04B 7/185

(52) U.S. Cl. CPC H04B 7/18506

(57) ABSTRACT

The development relates to the detection of drones. The use of a cellular communication network by drones may cause problems because of interference generated by a user device located on-board a drone flying higher than antennas of the base stations. It is important, for a telecommunications operator, to be able to control use of the cellular communication network by drones. Methods allowing drones to be detected exist. These methods, although they allow a location of a drone to be determined, do not provide a satisfactory detection accuracy. Likewise, they do not allow two drones in similar positions to be distinguished between. The method is based on the use of control signals the characteristics of which are known and on the use of known properties of the transmission channel set up between the base station and the user device, to determine an altitude value that is accurate and reliable.

### CROSS-REFERENCE TO RELATED APPLICATIONS

This application is filed under 35 U.S.C. § 371 as the U.S. National Phase of Application No. PCT/FR2021/050468 entitled “METHOD FOR DETECTING A DRONE WITH A USER EQUIPMENT LOCATED ON-BOARD, CORRESPONDING DEVICES AND COMPUTER PROGRAMS” and filed Mar. 22, 2021, and which claims priority to FR 2003044 filed Mar. 27, 2020, each of which is incorporated by reference in its entirety.

### BACKGROUND

### Field

The field of the development is that of drones embedding user equipments capable of communicating with a base station. More particularly, the development relates to the detection of such drones by devices of a communication network to which the user equipment is attached.

### Description of the Related Technology

The use of drones or UAVs (“Unmanned Aerial Vehicle”) known for military purposes is tending to develop in the civilian field, particularly for professional and recreational purposes.

These drones are generally controlled by means of a direct radio signal exchanged between the drone and a controller device. In order to increase the distance between the controller device and the drone, particularly for professional use, the direct communication established between the drone and its controller device is replaced by a communication established through a cellular communication network. In such a case, the drone, and possibly its controller device, are equipped with a user equipment attached to a cellular communication network. Such a configuration based on the use of a cellular communication network is likely to develop.

However, the use of a cellular communication network by user equipments embedded in drones may cause problems because of interference generated by this user equipment embedded in a drone flying higher than the antennas of the base stations constituting the cellular communication network, whereas the cellular communication network has been configured to communicate with user equipments located lower than the antennas of the base stations.

It is therefore important for a telecommunications operator to be able to control access to the cellular communication network and the use made of it by user equipments embedded indrones, that is, to allow such use when the operator has decided to offer it, and to users for whom such use is authorised, for example those who have subscribed to a specific offer. Such a need is also expressed in the TS 22.125 specification: “The 3GPP system should enable UTM to associate the drone and UAV controller, identify them as a UAS” published by the 3GPP (Third Generation Partnership Project) standardisation body.

User equipments embedded indrones have the possibility to identify themselves as being located on-board a drone to devices of a cellular communication network through a dedicated indicator included in a field of a signalling message exchanged with a device of the cellular communication network during the procedure of attaching the user equipment to the cellular communication network. The definition of such an indicator can be found in the document referenced by the following link: https://list.etsi.org/scripts/wa.exe?A3=ind2003B&L=3GPP TSG SA WG2&E=base64&P=13954657& B=−004 BY5PR02MB68333650 ESEC09371CEB07DD81FF0BY5PR02MB6833namp &T=application %2Fm sword;%20name=%22S2-200abcd-FS ID UAS-SA2 RID-identificationAuthOverview.doc %22&N=S2-

In the rest of the document, for simplification purposes, the term “identify as a drone” is used to mean that a user equipment embedded in a drone identifies itself as being on-board a drone. However, some user equipments embedded in drone do not identify themselves as such to the cellular communication network.

Methods exist allowing drones to be detected without their knowledge such as the method described in Phuc Nguyen, Taeho Kim, Jinpeng Miao, Daniel Hesselius, Erin E Kenneally, Dan Frank Massey, Eric W Frew, Richard Han, Tam Vu, “Towards RF-based Localization of a Drone and Its Controller”, DroNet'19: Proceedings of the 5th Workshop on Micro Aerial Vehicle Networks, Systems, and Applications-June 2019-Pages 21-26.

Such a method is based on the analysis of radio signals coming from a user equipment embedded in a drone, without a priori knowledge of the messages transmitted by the user equipment, only the carrier frequency and the frequency band of these radio signals being known a priori. The system comprises two detection modules capable of identifying the directions from which the radio signals transmitted by the user equipment embedded in the drone and by the controller device of the drone are received. Each detection module comprises an omnidirectional antenna for detecting radio signals from the user equipment embedded in the drone and a directional antenna for identifying the directions of the radio signals transmitted from the user equipment embedded in the drone and by the controller device.

Each detection module extracts information from the radio signal transmitted by the user equipment embedded in the drone and uses the directional antenna to identify the angles of incidence of the radio signals. By combining the information obtained by each of the two detection modules, it is possible to obtain the location of the user equipment embedded in the drone, and consequently, of the drone itself and its controller device.

Such a method, although allowing the location of a drone and its controller device to be determined, does not provide satisfactory detection accuracy, especially in a context of multipath propagation of the radio signals transmitted by the user equipment embedded in a drone. Similarly, such a method does not allow two drones to be distinguished if their positions are close.

There is thus a need for a drone detection solution that does not have some or all of the drawbacks mentioned.

### SUMMARY

The development meets this need by providing a method for determining, from a plurality of receive beams of said base station, a receive beam through which at least one control signal transmitted by the user equipment is received,
determining, from a plurality of receive beams of said base station, a receive beam through which at least one control signal transmitted by the user equipment is received,
detecting the drone as a function of at least one parameter determined from said at least one control signal received through said determined receive beam.

Such a detection method is based on the use of control signals transmitted by a user equipment embedded in a drone and the detection of these control signals by a base station equipped with a plurality of receive antennas. These control signals are transmitted by the user equipment for data communication through the cellular communication network. Some control signals are necessary to enable the base station to correctly demodulate the data transmitted by the user equipment and other control signals, or sometimes the same ones, are used by the base station to adapt its transmission parameters to the user equipment. Examples of control signals or Reference Symbols (RS) for 5G are given in document TS 38.211 published by 3GPP.

This plurality of receive antennas of the base station can apply processing to the control signals received on each antenna. Such processing is defined so that the result of its application to the received control signals gives an indication of the received power in a given direction. Such receive processing is usually predefined when the base station is installed. Each processing corresponds to a receive beam the direction of which in space is indicated, among other things, by an elevation angle.

Thus, the detection method consists in identifying a receive beam through which the control signals transmitted by the user equipment are received based on a receive power value of the control signals calculated for all receive beams.

Since the control signals used are specific to a given user equipment, the base station has the information necessary to identify that user equipment with certainty.

As the control signals are signals transmitted by all user equipments connected to a base station, whether located on-board a drone or not, it is possible to use them to determine that a user equipment is embedded in a drone without the knowledge of the user equipment and thus the owner of the drone.

According to one feature of the detection method, said at least one parameter is an altitude of the user equipment determined from a value of an elevation angle associated with the receive beam through which said at least one control signal is received, and wherein the drone is detected when the altitude of the user equipment is greater than or equal to a detection threshold.

Once the receive beam has been identified, the altitude of the user equipment embedded in a drone, and thus by extension, of the drone is calculated as a function of the distance separating the base station from the user equipment and as a function of the elevation angle of the receive beam.

According to one feature of the detection method, said at least one parameter comprises a plurality of power spectral density values representative of the vibrations produced by a drone.

By studying the frequency response of the received control signals, it is possible to detect, in a particular frequency band of the frequency response, power spectral density values representative of vibrations produced by a drone.

Indeed, the vibrations produced by a drone in a flight situation have an influence on the control signals transmitted by the user equipment and received by the base station. Such vibrations appear in the frequency response of the control signal(s) received by the base station.

In one embodiment of the detection method, when an altitude of the user equipment is lower than a detection threshold, said at least one parameter comprises a plurality of power spectral density values representative of vibrations produced by a drone.

In this other embodiment, the detection method allows a drone to be detected although the altitude of the drone is lower than the detection threshold. Indeed, when the presence of vibrations produced by a drone UAV is detected in the frequency response of the received control signals, and although the altitude of the user equipment is lower than the detection threshold, it is considered that the user equipment is embedded in a drone.

It is then possible to detect a drone early, that is, shortly after take-off, or a drone flying at a deliberately low altitude.

According to one feature of the detection method, the altitude of the user equipment is determined as a function of at least one of the following parameters:
a distance between the base station and the user equipment,
a receive power of said at least one control signal,
a signal propagation loss law.

Since the detection method is based on the use of control signals the characteristics of which, such as transmission power, are known and on the use of known properties of the propagation channel established between the base station and the user equipment, such as the signal propagation loss law through the propagation channel, the value of the altitude determined when performing the detection method is accurate and reliable.

According to another feature, the detection method further comprises a step of transmitting, to a management entity of the network, a message comprising the altitude of the drone and/or an indication of the detection in the frequency response of said at least one received control signal of a plurality of power spectral density values representative of vibrations produced by a drone.

The base station transmits the results of the detection method, altitude and/or presence of vibrations representative of a drone in the frequency response of the received control signals, to a management entity of the network. This management entity of the network, depending on whether or not the user equipment is embedded in a drone, decides whether or not to maintain an established communication session between the user equipment and a device of a cellular communication network through the base station.

According to a characteristic of the detection method, the step of determining, from a plurality of receive beams of said base station, a receive beam through which at least one control signal is received consists in:
determining, for at least one receive beam, a value of a receive power of said control signal received through said beam:

$${w}^{( r )} = {\vert {p}^{( r )} {h}^{( r )} {s}^{pilot} \vert}^{2} = {\vert {\sum }_{i = 1}^{N} {p}_{i}^{( r )} {h}_{i}^{( r )} {s}^{pilot} \vert}^{2}$$

where S^{pilot} is the control signal, w^{(r)} represents the value of the receive power of the control signal, pᵢ^{(r)} is a row vector of complex coefficients of dimension N×1 representing a receive beam; hᵢ^{(r)} is a column vector of complex coefficients of dimension 1×N representing an estimate of a propagation channel, for a predefined subcarrier, between the base station and the user equipment, N is the number of receive antennas of the base station and re {1, . . . , R} where R is the number of receive beams of the base station,
determining the receive beam for which the value of the receive power of said at least one control signal is greater than the value of the receive power of said at least one control signal determined for the other receive beams.

The selected receive beam is that having a greater value of the receive power than the other receive beams. In other words, the selected receive beam is that the direction of which in space is closest to the direction in space from which the control signals transmitted by the user equipment come.

In one embodiment of the detection method, the altitude of the user equipment is determined as follows:

h˜H+sign(e^{r}^{ₘₐₓ})×d×cos(e^{r}^{ₘₐₓ})

where his the altitude of the user equipment, His the altitude of the base station, e^{r}^{ₘₐₓ} is the elevation angle of the receive beam for which the value of the receive power of the at least one control signal is greater than the value of the receive power of said at least one control signal determined for the other receive beams, d is the distance between the base station and the user equipment, and sign(x)=1 if x>0 otherwise sign(x)=−1.

The value of the elevation angle is positive when the receive beam is above a horizontal plane passing the top of the base station and the value of the elevation angle is negative when the receive beam is below the same horizontal plane. Thus, a negative value of the elevation angle implies that the user equipment is at a lower altitude than the base station.

The development also relates to a method for communicating between a management entity of the network and a user equipment embedded in a drone, the method being implemented by the management entity of the network comprising the steps of:
receiving a message, transmitted from a base station to which the user equipment is connected, comprising an altitude of the drone and/or an indication of a detection of vibrations produced by a drone in a frequency response of at least one control signal transmitted by the user equipment and received by the base station,
transmitting a message to the user equipment requesting it to identify itself as a drone when it is determined that the detected altitude and/or vibrations correspond to a drone.

This management entity of the network transmits the information that the user equipment is or is not embedded in a drone to an entity of a cellular communication network capable of deciding whether to maintain an established communication session between the user equipment and a device of a cellular communication network through the base station.

In an alternative embodiment of the communication method, the method comprises, when the user equipment does not identify itself as a drone, a step of breaking a communication session established between the user equipment and a device of a communication network through the base station.

The development further relates to a base station capable of detecting a drone with a user equipment located on-board connected to said base station, the base station comprising means for:
determining, from a plurality of receive beams of said base station, a receive beam through which at least one control signal transmitted by the user equipment is received,
determining an altitude of the user equipment as a function of a receive power of said at least one control signal, and a value of an elevation angle associated with the receive beam through which said at least one control signal is received,
detecting the drone when the altitude of the user equipment is greater than or equal to a threshold.

Such a base station is, for example, a “next generation NodeB” (gNB) type device.

According to one feature of the base station, the latter also comprises means for transmitting, to a management entity of the network, a message comprising the altitude of the drone and/or an indication of the detection in the frequency response of said at least one received control signal of a plurality of power spectral density values representative of the vibrations produced by a drone.

The development further relates to a management entity of the network capable of communicating with user equipment embedded in a drone, the management entity of the network comprising means for:
receiving a message, transmitted by a base station to which the user equipment is connected, comprising an altitude of the drone and/or an indication of a detection of vibrations produced by a drone in a frequency response of at least one control signal transmitted by the user equipment and received by the base station,
transmitting a message to the user equipment requesting it to identify itself as a drone when it is determined that the detected altitude and/or vibrations correspond to a drone.

In one embodiment of the management entity of the network, the latter comprises, when the user equipment does not identify itself as a drone, means for implementing a break in a communication session established between the user equipment and a device of a communication network through the base station.

The development finally relates to computer program products comprising program code instructions for implementing the methods as described above, when executed by a processor.

The development also relates to a computer-readable storage medium on which computer programs comprising program code instructions for performing the steps of the methods according to the development as described above are stored.

Such a recording medium may be any entity or device capable of storing the programs. For example, the medium may comprise a storage medium, such as a ROM, for example a CD ROM or a microelectronic circuit ROM, or a magnetic recording medium, for example a USB stick or a hard disk.

On the other hand, such a recording medium may be a transmissible medium such as an electrical or optical signal, which may be conveyed via an electrical or optical cable, by radio or by other means, so that the computer programs contained therein are remotely executable. The programs according to the development may in particular be downloaded over a network, for example the Internet.

Alternatively, the recording medium may be an integrated circuit in which the programs are incorporated, the circuit being adapted to perform or to be used in performing the aforementioned methods which are the objects of the development.

### BRIEF DESCRIPTION OF THE DRAWINGS

Other purposes, characteristics and advantages of the development will become clearer upon reading the following description, which is given by way of a simple illustrative example, and is not limitative, in relation to the figures, among which:

FIG. 1 represents a system in which the method for detecting a drone is implemented,

FIG. 2 represents the different steps implemented when performing the detection method and the communication method which are the objects of the development,

FIG. 3 represents an example of frequency response in which such vibrations can be detected,

FIG. 4 represents a base station according to an embodiment of the development,

FIG. 5 represents a management entity of the network according to an embodiment of the development.

### DETAILED DESCRIPTION OF CERTAIN ILLUSTRATIVE EMBODIMENTS

The general principle of the development is based on the use of control signals transmitted by a user equipment located on-board, or embedded in, a drone and the detection of these control signals by a base station equipped with a plurality of receive antennas. This plurality of antennas can apply a predefined processing to the control signals received on each receive antenna of the base station. This processing is defined so that the result of its application to the received control signals gives an indication of the power received in a given direction. Each receive processing corresponds to a receive beam the direction of which in space is indicated, inter alia, by an elevation angle. Once the receive beam has been identified, through which the control signals are received with the highest receive power value among all the receive beams, the altitude of the drone is calculated as a function of the distance separating the base station from the user equipment and as a function of the elevation angle of the identified receive beam, thus enabling the drone to be detected.

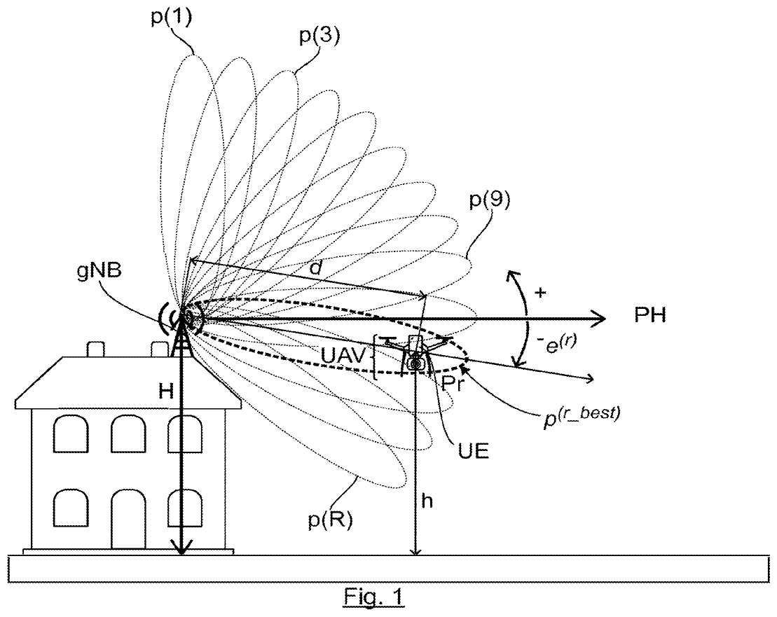

In relation to FIG. 1 a system in which the method for detecting a drone is implemented, is now set forth.

The system comprises at least one drone UAV with a user equipment UE located on-board. The drone UAV is at an altitude h.

The system also comprises a base station gNB, such as an equipment gNB, located on a building. The base station gNB is at an altitude H. Such a base station gNB comprises N receive antennas, not represented in the figure. R receive beams p^{(r)} r∈{1, . . . , R} are associated with the N receive antennas of the base station gNB. Each of the R receive beams p^{(r)} corresponds to a direction in space. Such a direction is represented by a value of an elevation angle e^{r}. The value of the elevation angle e^{r} positive when the associated received beam is above a horizontal plane PH passing the top of the base station gNB and the value of the elevation angle e^{r} is negative when the associated received beam is below this same horizontal plane PH.

Finally, d represents the distance between the base station gNB and the drone UAV or user equipment UE.

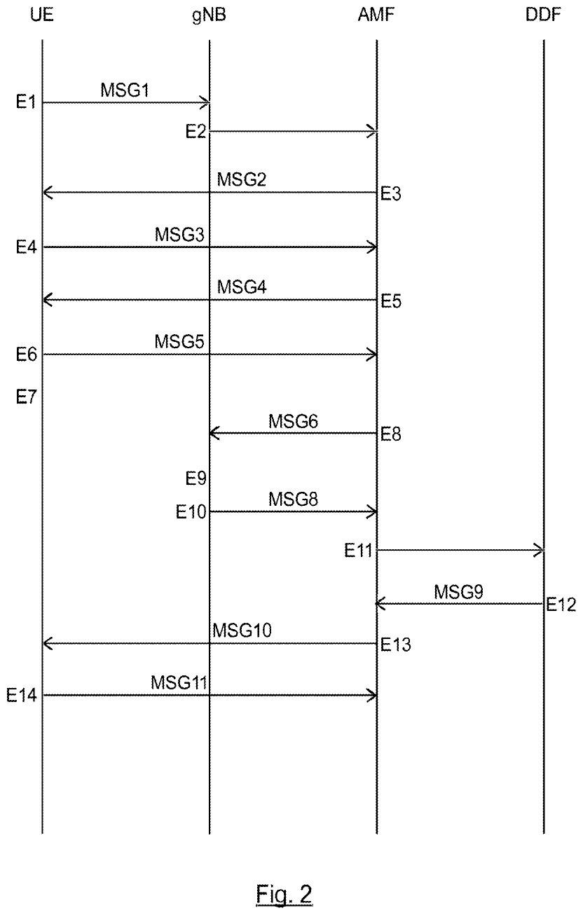

FIG. 2 represents the different steps implemented when performing the detection method and the communication method which are the objects of the development.

In a step E1, the user equipment UE transmits a first message MSG1 to request registration with a device of a cellular communication network to the base station gNB.

In a step E2, the message MSG1 is transmitted by the base station to a management entity AMF of the network. The details of the exchanges between the user equipment UE, the base station gNB and the management entity AMF of the network are specified in document TS 38.331 version 15.8.0 published by 3GPP.

During a step E3, the management entity AMF of the network transmits an identification request MSG2 to the user equipment so that the latter authenticates itself as a drone to the cellular communication network.

The user equipment UE responds to this message MSG2 during a step E4 by transmitting a message MSG3 to the management entity AMF of the network. The message MSG3 may either comprise the identity of the drone with the user equipment UE located on-board, or it may indicate that the user equipment UE is not located on-board a drone. This exchange of messages between the user equipment UE and the management entity AMF of the network may occur between steps 19 and 21 of the procedure specified in document TS 23.501 version 15.8.0 clause 4.2.2.2.2 published by 3GPP, or at another point in that procedure. In a particular embodiment, the step is not implemented. In this case, the lack of transmission of a message MSG3 by the user equipment is considered as an indication that the user equipment UE is not located on-board a drone UAV.

In a step E5, the management entity AMF of the network transmits a message MSG4 to confirm the registration of the user equipment UE with the cellular communication network.

During a step E6, the user equipment UE transmits a message MSG5 to request the establishment of a data session with a device of the cellular communication network to the management entity AMF of the network, which in turn relays it to a device of the cellular communication network in charge of establishing and managing this session. Such a procedure is specified in document TS 23.502 version 15.8.0 clause 4.3.2.2.1 or 4.3.2.2.2 published by 3GPP.

In a step E7, the drone UAV takes off. The devices of the cellular communication network are not informed of this event.

These steps E1 to E6 do not directly trigger the step E7 and following steps, but are for example prerequisites in order to ensure that the detection method and the communication process which are the objects of the development are properly performed.

In a step E8, the management entity AMF of the network transmits a message MSG6 to the station gNB requesting it to carry out measurements in order to detect the presence of possible drones. This step E8, can be triggered at the expiration of a timeout the starting point of which is set by the management entity AMF of the network, and can be repeated over time. According to another embodiment, it is the base station gNB itself that triggers the measurements.

During a step E9, the base station gNB carries out the measurements. The base station gNB receives, on its N receive antennas, SRS control signals transmitted by the user equipment UE such as Sounding Reference Signals. Such SRS control signals are transmitted regularly by the user equipment UE.

The base station gNB estimates for each of its N receive antennas, according to known methods, a complex coefficient representative of a propagation channel established between the user equipment UE and the considered receive antenna. The result of this estimation is a vector h. The vector h is a complex column vector of dimension 1×N, in which all coefficients hᵢ are arranged, the coefficient hᵢ being the coefficient corresponding to the antenna i of the base station gNB.

R receive beams p^{(r)}, with r∈{1, . . . , R}, are associated with the N receive antennas of the base station gNB. A receive beam is represented by a p^{(r)}. The vector p^{(r)} is a complex line vector of dimension N×1. Each p^{(r)} vector is pre-calculated according to known methods in the beamforming field to point, in reception, in a given direction in space relative to the receive antenna of the base station gNB. For example, if the base station gNB is equipped with a rectangular, so-called “upright”, that is, perpendicular to the ground surface, regular array of antennas comprising M horizontal lines numbered m=0 . . . M−1 from highest to lowest in altitude, and Q vertical columns numbered q=0 . . . Q−1, from left to right, the receive beams can be constructed from coefficients of a two-dimensional Discrete Fourier Transform of size M×Q=N as indicated below:

$${p}_{n}^{( r )} = {e}^{J 2 π \frac{m \times μ ( r )}{M}} {e}^{J 2 π \frac{q \times φ ( r )}{Q}} ,$$

where:

m=0 . . . M−1

q=0 . . . Q−1

n=M×q+m

μ(r)∈[0;M−1]

φ(r)∈[0;Q−1]
If r≠r′ the pair μ(r), φ(r) is distinct from the pair μ(r), φ(r) (the pair as a whole must be distinct, it is not necessary that μ(r′)≠μ(r) and φ(r′)≠φ(r) at the same time),
where r is a receive beam, μ(r) represents a vertical direction or elevation, and has a value between 0 and M, and φ(r) represents a horizontal direction and has a value between 0 and Q.

The elevation angle corresponding to this receive beam r is given as a function of

$$θ ( r ) = 2 π \frac{μ ( τ )}{M} by :$$

θ(r) is 0≤θ(r)≤π/2 or 3π/2≤θ(r)≤2 (positive elevation angle the value of which is between 0 and π/2)

$$\frac{π}{2} - θ ( r )$$

is π/2≤θ(r)≤3π/2 (negative elevation angle the value of which is between 0 and −π/2)

There exists at least one pair (r, r′) such that r≠r′ and μ(r′)≠μ(r) to obtain at least two receive beams (r, r′) corresponding to distinct elevation angles between which the base station gNB can choose.

Let E={e⁽¹⁾, . . . , e^{(R)}} be a set of elevation angles corresponding to each receive beam. The following convention is assumed: when e>0, the direction points above the horizontal plane PH, when e<0 the direction points below the horizontal plane PH.

For example, in the case of a multi-carrier waveform communication system of the orthogonal frequency division multiplex type as described in [Y. Liu, Z. Tan, H. Hu, L. J. Cimini and G. Y. Li, “Channel Estimation for OFDM,” in IEEE Communications Surveys & Tutorials, vol. 16, no. 4, pp. 1891-1908, Fourthquarter 2014], the base station gNB determines a value of a receive power of the SRS control signals received through each receive beam as follows:

$${w}^{( r )} = {\vert {p}^{( r )} {h}^{( r )} {s}^{pilot} \vert}^{2} = {\vert {\sum }_{i = 1}^{N} {p}_{i}^{( r )} {h}_{i}^{( r )} {s}^{pilot} \vert}^{2}$$

where S^{pilot} is the control signal, w^{(r)} represents the value of the receive power of the control signal, pᵢ^{(r)} is a row vector of complex coefficients of dimension N×1 representing a receive beam;
hᵢ^{(r)} is a column vector of complex coefficients of dimension 1×N representing an estimate of a propagation channel, for a predefined subcarrier, between the base station and the user equipment, Nis the number of receive antennas of the base station and r∈{1, . . . , R} where R is the number of receive beams of the base station.

w^{(r)} corresponds to the result of the predefined processing applied to the received control signals.

The base station gNB then determines the receive beam with the highest receive power value among all calculated receive power values. In a particular embodiment, the base station determines the receive beam for which the value of the receive power is maximum:

$${r}_{max} = arg ( {max}_{r} ( {w}^{( r )} ) ) .$$

The base station gNB deduces the corresponding elevation angle e^{r}^{ₘₐₓ}.

The base station gNB then determines the distance d at which the user equipment UE is. For example, knowing a value of a transmission power of the SRS control signals, and knowing a signal propagation loss law

$$f ( d ) = \frac{α}{d β} ,$$

which defines the power loss f(d) of a signal due to the propagation of this signal between a user equipment located at a distance d and a receive antenna of a base station gNB, and the coefficients of which α and β have for example been measured at the time of installation and pre-recorded in the base station gNB, the base station gNB measures a value of a receive power of the SRS control signals received at at least one of its receive antennas, and deduces the distance d therefrom.

For example, if the base station gNB is based on a measurement of a value of a receive power of the SRS control signals received by a single receive antenna, the distance d is estimated as follows:

$$d ∼ \frac{1}{β} log ( \frac{Pt}{Pr} ) .$$

Knowing the value of the distance d, the base station gNB then determines the altitude h of the user equipment UE. As an example, the altitude h of the UE is calculated as follows:

h˜H+sign(e^{r}^{ₘₐₓ})×d×cos(e^{r}^{ₘₐₓ}).

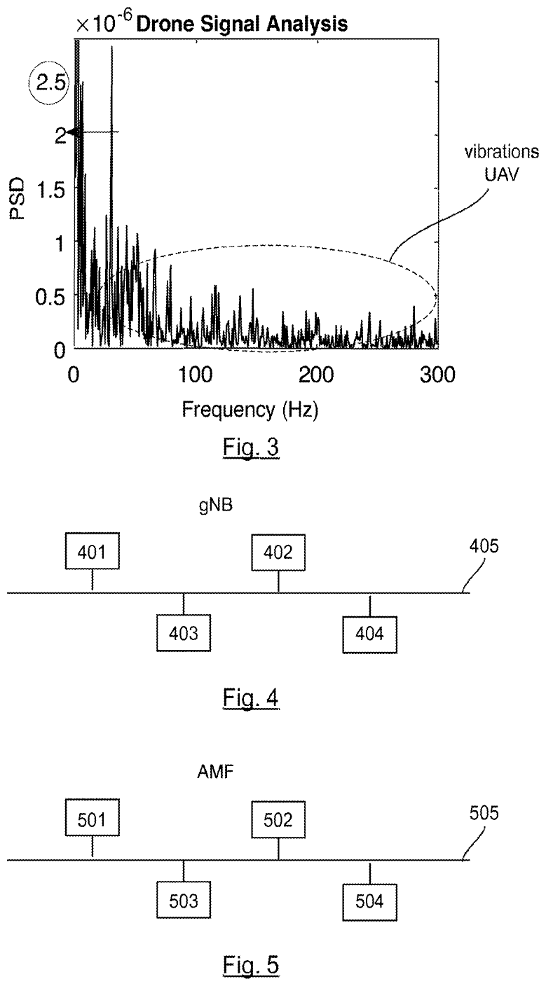

In a particular embodiment, in the case of an OFDM (orthogonal frequency-division multiplexing) type communication system, the base station gNB also estimates the propagation channel h^{(k)} for each subcarrier number k=1 . . . K of the OFDM waveform, and deduces the frequency response therefrom, for a predefined receive antenna number n, as the set of hₙ^{(k)}∈ [symbol] . Each subcarrier corresponds to a predefined frequency. The base station gNB analyses the frequency response thus obtained in order to detect, for a particular set of subcarriers {k1, k2, . . . } corresponding to a particular band of frequency values, a plurality of values of {|hₙ^{(k1)}|², |hₙ^{(k1)}|², . . . }, corresponding to a plurality of power spectral density values representative of vibrations produced by a drone UAV in flight with the user equipment transmitting the OFDM waves located on-board. An example of a frequency response in which such vibrations can be detected is shown in FIG. 3.

Indeed, the vibrations produced by a drone UAV in a flight situation have an influence on the control signals transmitted by the UE and received by the base station. Such vibrations appear in the frequency response of the control signals.

In a first embodiment, the base station gNB performs a series of two tests in order to determine whether the UE is on-board a drone UAV. In a first test the base station gNB determines whether the altitude h of the UE is above a detection threshold.

When this is the case, the base station gNB optionally performs a second test to determine the presence of vibrations produced by a drone UAC in the frequency response of the received control signals and thus confirm that the user equipment UE is on-board a drone.

When the altitude h of the UE is below a detection threshold, the base station gNB optionally performs a second test to determine the presence of vibrations produced by a drone UAV in the frequency response of the received control signals to determine that the user equipment UE is embedded in a drone.

In a second embodiment, the base station gNB is able to detect a drone UAV although the altitude h of the drone is below the detection threshold. For this purpose, the base station gNB also performs a series of two tests to determine whether the user equipment UE is embedded in a drone UAV. In a first test, the base station gNB determines whether vibrations produced by a drone UAV are present in the frequency response of the received control signals.

When this is the case, the base station gNB optionally performs a second test to determine whether the altitude h of the UE is above or below a detection threshold. Indeed, when the presence of vibrations produced by a drone UAV is detected in the frequency response of the received control signals, it is considered that the user equipment UE is embedded in a drone UAV, regardless of the altitude h of the UE, however, information about the altitude of the drone may be useful to confirm a detection result.

It is then possible to detect a drone early, that is, shortly after its take-off, or a drone flying at a deliberately low altitude.

During a step E9, the base station gNB sends a message MSG8 to the management entity AMF of the network. The message MSG8 comprises an estimate of the altitude h of the user equipment UE. This altitude is expressed in relation to ground level, but another reference level could be used, for example sea level, the level of the base station gNB or the level of the top of the highest building in the vicinity of the base station gNB. The last example distinguishes between a device located on-board a drone and“a “nor”al” user equipment UE on the top floor of a tower, for example.

The message MGS8 also comprises, as a function of the embodiment implemented, “a “drone vibration similarity in”ex”, the presence of this index indicates that a plurality of power spectral density values representative of vibrations produced by a drone UAV have been detected in the frequency response of the received control signals.

In a step E10, the management entity AMF of the network transmits the information comprised in the message MSG8 to a drone detection device DDF in order to confirm that the user equipment UE is indeed embedded in a drone UAV. Alternatively, the management entity AMF of the network performs this verification itself and no information is transmitted to the drone detection device DDF.

Upon receipt of the information transmitted by the management entity AMF of the network, the drone detection device DDF performs, during a step E11, a tracking of the location of the user equipment UE using known methods and analyses the trajectory of the user equipment UE by cross-referencing it, for example, with mapping data. This tracking may continue for an extended period of time.

The drone detection device DDF may obtain statistical information about the mobility of the user equipment UE from a device specialised in analysing data from the network. This statistical information may relate to a longer or shorter period of time in the past. Such a procedure is specified in document TS 23.288 clause 6.7.2 published by 3GPP.

In a step E12, the drone detection device DDF transmits a message MSG9 to the management entity AMF of the network. As a function of the level of certainty resulting from the analysis of the information collected during step E11 that the user equipment UE is embedded in a drone UAV, the message MSG9 includes”a “posit”ve“, “negat”ve” “r “unkn”wn” indicator.

If the indicator included in the message MSG9 “s “negat”ve”, the management entity AMF of the network requests the base station to implement step E9 again after a timeout of duration T1. If the indicator in the message MSG9 “s “unkn”wn”, the management entity AMF of the network shall request the base station to implement step E9 again after a timeout of duration T2<T1.

If the indicator included in the MSG9 message “s “positive”, the management entity AMF of the network sends, in a step E13, to the user equipment UE a message MSG10 requesting it to identify itself as a drone UAV to the cellular network device. In another embodiment, the management entity AMF of the network does not send a message to the UE but directly sends an Nsmf_PDUSession_Release message (as defined in document TS 23.502 clause 5.2.8.2.4 published by 3GPP) to a cellular communication network device to trigger a break in the communication session established in step E6. As a result, the user equipment UE no longer has any connectivity but remains registered in the cellular communication network, allowing it to continue to be tracked by performing some of the steps E8 to E12 again.

In a step E14, the user equipment UE responds by transmitting a message MSG11 identifying it as being on-board a drone UAV. According to another embodiment, the user equipment UE does not respond but performs step E1 again indicating that it is on-board a drone UAV.

In case the user equipment UE maintains its connection without identifying itself as a user equipment UE embedded in a drone UAV (that is, it does not perform step E14 within a certain time period after receiving the message MSG10 transmitted by the management entity AMF of the network during step E13, the management entity AMF of the network sends an Nsmf_PDUSession_Release message to a device of the cellular communication network to trigger a break in the communication session established in step E6.

In another embodiment, the management entity AMF of the network sends an Nsmf_PDUSession_UpdateSMContext message, as defined in document TS 23.502 clause 5.2.8.2.6 published by 3GPP, to a device of the cellular communication network. Such an Nsmf_PDUSession_UpdateSMContext message is modified to comprise an indication that the UE has been detected as being on-board a drone UAV without having identified itself as a drone UAV. This information is stored for transmission to a billing system. Thus, the connectivity of the user equipment UE is maintained but it may be taken into account at the commercial level of the “faulty” behavior of the user of the user equipment UE who has not configured the latter so that he declares himself to the cellular communication network as being embedded in a drone.

In another embodiment, it is possible to limit the communication rate of the user equipment UE to a very low value, for example 100 kb/s, which has the effect of limiting the rate of the data session established in step E6 to that value. Thus, the user equipment UE is penalized without its connectivity being completely interrupted.

Furthermore, the management entity AMF of the network may reject for a certain period of time, or until the user equipment UE identifies itself as a user equipment UE on-board a drone UAV, any subsequent request to establish a data session that the user equipment UE may transmit.

FIG. 4 represents a base station gNB according to an embodiment of the development. Such a base station gNB is capable of implementing the various embodiments of the methods described with reference to FIG. 2.

A base station gNB may comprise at least one hardware processor 401, a storage unit 402, an interface 403, and at least one network interface 404 which are connected to each other through a bus 405. Of course, the constituent elements of the base station gNB may be connected by means of a connection other than a bus.

The processor 401 controls the operations of the base station gNB. The storage unit 402 stores at least one program for implementing the methods according to an embodiment of the development to be executed by the processor 401, and various data, such as parameters used for calculations performed by the processor 401, intermediate data of calculations performed by the processor 401, etc. The processor 401 may be formed by any known and suitable hardware or software, or by a combination of hardware and software. For example, the processor 401 may be formed by dedicated hardware such as a processing circuit, or by a programmable processing unit such as a central processing unit that executes a program stored in a memory thereof.

The storage unit 402 may be formed by any suitable means capable of storing the program or programs and data in a computer-readable manner. Examples of storage unit 402 include non-transitory computer-readable storage media such as solid-state memory devices, and magnetic, optical or magneto-optical recording media loaded into a read/write unit.

Interface 403 provides an interface between the base station gNB and the user equipment UE.

At least one network interface 404 provides a connection between the base station gNB and the management entity AMF of the network.

FIG. 5 represents a management entity AMF of the network according to an embodiment of the development. Such a management entity AMF of the network is capable of implementing the various embodiments of the methods described with reference to FIG. 2.

A management entity AMF of the network may comprise at least one hardware processor 501, a storage unit 502, an interface 503, and at least one network interface 504 that are connected to each other through a bus 505. Of course, the constituent elements of the management entity AMF of the network may be connected by means of a connection other than a bus.

The processor 501 controls the operations of the management entity AMF of the network. The storage unit 502 stores at least one program for implementing the methods according to an embodiment of the development to be executed by the processor 501, and various data, such as parameters used for calculations performed by the processor 501, intermediate data of calculations performed by the processor 501, etc. The processor 501 may be formed by any known and suitable hardware or software, or by a combination of hardware and software. For example, the processor 501 may be formed by dedicated hardware such as a processing circuit, or by a programmable processing unit such as a central processing unit that executes a program stored in a memory thereof.

The storage unit 502 may be formed by any suitable means capable of storing the program or programs and data in a computer-readable manner. Examples of storage unit 502 include non-transitory computer-readable storage media such as solid-state memory devices, and magnetic, optical or magneto-optical recording media loaded into a read/write unit.

Interface 503 provides an interface between the management entity AMF of the network and the base station gNB.

At least one network interface 504 provides a connection between the management entity AMF of the network and other devices present in the cellular communication network.

1. A method for detecting a drone with a user device located on-board, the method being implemented by a base station to which the user equipment is connected, the method comprising:
determining, from a plurality of receive beams of the base station, a receive beam through which at least one control signal transmitted by the user equipment is received; and
detecting the drone as a function of at least one parameter determined from the at least one control signal received through the determined receive beam.

2. The method for detecting a drone according to claim 1, wherein the parameter comprises a plurality of power spectral density values representative of the vibrations produced by a drone.

3. The method for detecting a drone according to claim 1, wherein the at least one parameter comprises an altitude of the user equipment determined from a value of an elevation angle associated with the receive beam through which the at least one control signal is received, and wherein the drone is detected when the altitude of the user equipment is greater than or equal to a detection threshold.

4. The method for detecting a drone according to claim 2, wherein the drone is detected when an altitude of the user equipment is lower than a detection threshold.

5. The method for detecting a drone according to claim 3, wherein the altitude of the user equipment is determined as a function of at least one of the following parameters:
a distance separating the base station from the user equipment,
a receive power of the at least one control signal, and
a signal propagation loss law.

6. The method for detecting a drone according to claim 1, further comprising transmitting, to a management entity of a network, a message comprising the altitude of the drone and/or an indication of a detection in a frequency response of the at least one received control signal of a plurality of power spectral density values representative of vibrations produced by a drone.

7. The method for detecting a drone according to claim 1, wherein determining, from a plurality of receive beams of the base station, a receive beam through which at least one control signal is received comprises:
determining, for at least one receive beam, a value of a receive power of the control signal received through the beam:
$${w}^{( r )} = {\vert {p}^{( r )} {h}^{( r )} \vert}^{2} = {\vert {\sum }_{i = 1}^{N} {p}_{i}^{( r )} {h}_{i}^{( r )} \vert}^{2}$$
where w^{(r)} represents the value of the receive power of the control signal, pᵢ^{(r)} is a row vector of dimension N×1 representing a receive beam; hᵢ^{(r)} is a column vector of dimension 1×N representing an estimate of a transmission channel established between the base station and the user equipment, N is the number of receive antennas of the base station and r∈{1, . . . , R} where R is the number of receive beams of the base station; and
determining the receive beam for which the value of the receive power of the at least one control signal is greater than the value of the receive power of the at least one control signal determined for the other receive beams.

8. The method for detecting a drone according to claim 6, wherein the altitude of the user equipment is determined as follows:
h˜H+sign(e^{r}^{ₘₐₓ})×d×cos(e^{r}^{ₘₐₓ})
where h is the altitude of the user equipment, H is the altitude of the base station, e^{r}^{ₘₐₓ} is the elevation angle of the receive beam for which the value of the receive power of the at least one control signal is greater than the value of the receive power of the at least one control signal determined for the other receive beams, and d is the distance between the base station and the user equipment.

9. A method for communicating between a management entity of a network and a user equipment located on-board a drone, the method being implemented by the management entity of the network comprising:
receiving a message, transmitted from a base station to which the user equipment is attached, comprising an altitude of the drone and/or an indication of a detection of vibrations produced by a drone in a frequency response of at least one control signal transmitted by the user equipment and received by the base station; and
transmitting a message to the user equipment requesting it to identify itself as a drone when it is determined that the detected altitude and/or vibrations correspond to a drone.

10. The method for communicating between a management entity of the network and a user equipment embedded in a drone according to claim 9 comprising, when the user equipment does not identify itself as a drone, breaking a communication session established between the user equipment and a device of a communication network through the base station.

11. A base station capable of detecting a drone with a user equipment located on-board, attached to the base station, the base station comprising means for:
determining, from a plurality of receive beams of the base station, a receive beam through which the at least one control signal transmitted by the user equipment is received; and
detecting the drone as a function of at least one parameter determined from the at least one control signal received through the determined receive beam.

12. The base station capable of detecting a drone with a user equipment connected to the base station according to claim 11, further comprising means for transmitting, to a management entity of a network, a message comprising the altitude of the drone and/or an indication of a detection in a frequency response of the at least one received control signal of a plurality of power spectral density values representative of vibrations produced by a drone.

13. A management entity of a network capable of communicating with a user equipment embedded in a drone, the management entity of the network comprising means for:
receiving a message, transmitted by a base station to which the user equipment is connected, comprising an altitude of the drone and/or an indication of a detection of vibrations produced by a drone in a frequency response of at least one control signal transmitted by the user equipment and received by the base station; and
transmitting a message to the user equipment requesting it to identify itself as a drone when it is determined that the detected altitude and/or vibrations correspond to a drone.

14. The management entity of the network capable of communicating with a user equipment embedded in a drone according to claim 9, comprising, when the user equipment does not identify itself as a drone, means for implementing a break in a communication session established between the user equipment and a device of a communication network through the base station.

15. A processing circuit comprising a processor and a memory, the memory storing program code instructions of a computer program for implementing the method according to claim 1, when the computer program is executed by the processor.

16. The A processing circuit comprising a processor and a memory, the memory storing program code instructions of a computer program for implementing the method according to claim 9, when the computer program is executed by the processor.
